(19) United States
(12) Patent Application Publication
(10) Pub. No.: US 2013/0162872 A1
(43) Pub. Date: Jun. 27, 2013

(54) IMAGE SENSING DEVICE AND METHOD OF OPERATING THE SAME

(71) Applicant: SK Hynix Inc., Icheon-si Gyeonggi-do (KR)

(72) Inventor: Sung Yong LEE, Gunpo-si Gyeonggi-do (KR)

(73) Assignee: SK Hynix Inc., Icheon-si Gyeonggi-do (KR)

(21) Appl. No.: 13/626,086

(22) Filed: Sep. 25, 2012

(30) Foreign Application Priority Data
Dec. 22, 2011 (KR) 10-2011-0140322

(51) Int. Cl. H04N 5/202

(52) U.S. Cl. 348/254; 348/E05.074

(57) ABSTRACT

An image sensing device is operated by, inter alia: dividing a plurality of ranges with an available value width range of the image sensing device associated with a predetermined brightness level range, dividing a plurality of clusters with image data from a pixels array using the plurality of data ranges, and performing a clustering gamma correction process for each cluster with at least a clustering gamma correction factor corresponding to each cluster.

### CROSS-REFERENCE(S) TO RELATED APPLICATIONS

The present application claims priority of Korean Patent Application No. 10-2011-0140322, filed on Dec. 22, 2011, which is incorporated herein by reference in its entirety.

### BACKGROUND OF THE INVENTION

1. Field of Invention

Various embodiments of the present invention relate to an image sensing device, and more particularly, to a circuit for handling an image signal provided from a pixel.

2. Related Art

An image sensing device such as a portable camera or a digital camera typically generates images Sensing elements included in an image sensing device include a CMOS image sensor and a charge coupled device (CCD) image sensor. A CMOS image sensor and a CCD image sensor each have a pixel array that respond to light for capturing images.

Each subject in the natural world corresponds to a brightness and wavelengths of light. Each pixel of an image sensor extracts an electrical value by sensing brightness and wavelengths. The electrical value is converted into an electrical voltage that can be processed in the image sensor. An image sensor includes an analog-to-digital (A/D) converter which converts analog voltages sensed by the pixel array into digital values, and memory for use during signal processing.

A pixel array includes a plurality of pixels arranged in a matrix of columns and rows. The widest pixel array of available matrix forms includes a Bayer pattern. 50% green pixels, 25% red pixels, and 25% blue pixels are disposed in a Bayer pattern. The red pixels and the green pixels are alternately disposed in a single line, and the blue pixels and the green pixels are alternately disposed in a next line. One pixel contains information for only one color, for example red, blue, or green. Since every pixel data must have information for three colors to form an image, information for two colors not provided from a target pixel has to be extracted from pixels neighboring the target pixel. This process is generally called interpolation.

Interpolated data comprises of analog information that needs to be transformed into digital information via an analog-to-digital converting block. The digital data outputted from the analog-to-digital converting block may be directly used for creating an image. Some necessary processes, for instance, a noise removing process, are implemented before the digital data is used for creating an image. Image quality outputted from an image sensing device could depend on efficiency or characteristics of some necessary processes.

### SUMMARY OF THE INVENTION

An embodiment of the present invention is directed to an image sensing device and a method of operating the same.

In accordance with an embodiment of the present invention, a method for operating an image sensing device includes dividing a plurality of ranges with an available value width range of the image sensing device associated with a predetermined brightness level range, dividing a plurality of clusters with image data from a pixels array using the plurality of data ranges, and performing a clustering gamma correction process for each cluster with at least a clustering gamma correction factor corresponding to each cluster.

In accordance with an embodiment of the present invention, an image sensing device includes a clustering gamma correction unit for performing a clustering gamma correction process with image data from a pixels array, a normal gamma correction unit for performing a normal gamma correction process with image data from a pixels array, and an interpolation unit for interpolating data provided from the clustering gamma correction unit or the normal gamma correction unit.

### BRIEF DESCRIPTION OF THE DRAWINGS

FIG. 1 is a block diagram illustrating an image sensing device according to an embodiment of the present invention.

FIG. 2 is a block diagram illustrating a column ADC block and its peripheral circuit in the image sensing device of FIG. 1.

FIG. 3 is a timing diagram illustrating the operation of the column ADC block of FIG. 2.

FIG. 4 is a block diagram illustrating an image sensing device in accordance with an embodiment of the present invention.

FIG. 5 illustrates an operation of a gamma correction unit of the image sensing device of FIG. 4.

FIG. 6 shows an image handled by the gamma correction unit of the image sensing device of FIG. 4.

### DESCRIPTION OF SPECIFIC EMBODIMENTS

Various embodiments of the present invention will be described below in more detail with reference to the accompanying drawings. The present invention may, however, be embodied in different forms and should not be constructed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

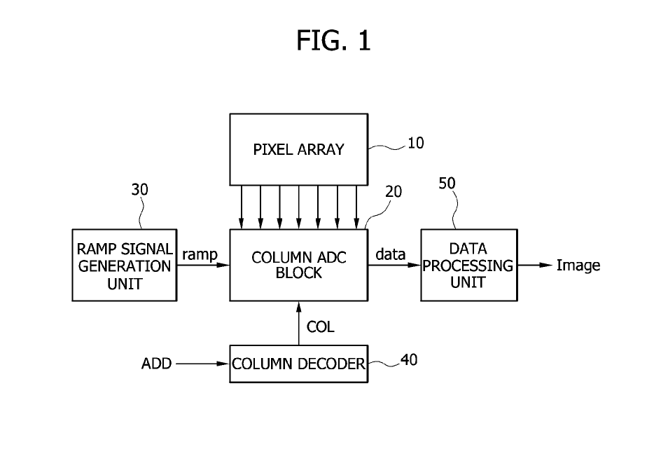

FIG. 1 is a block diagram illustrating an image sensing device, shown as an example to explain an aspect of the present invention.

Referring to FIG. 1, the image sensing device includes a pixel array 10, a column ADC block 20, a ramp signal generation unit 30, a column decoder 40, and a data processing unit 50. The pixel array 10 includes a plurality of pixels arranged in columns and rows in matrix form. A single pixel may include three or four transistors (not shown) and a photodiode (not shown). The photodiode is an element which accumulates electrons corresponding to incident light, and the plurality of transistors provided in the pixel output a signal corresponding to the accumulated electrons. In the pixel array 10, a plurality of pixels may be arranged in columns and rows in a matrix form. Signals outputted from the respective pixels are processed in units of columns.

The column ADC block 20 includes as many comparison units and latch units as the number of the columns provided in the pixel array 10. The ramp signal generation unit 30 generates a ramp signal ramp where the level of the ramp signal ramp decreases at a constant rate during a predefined period, and provides the ramp signal ramp input to the column ADC block 20. The column decoder 40 receives an address signal ADD and provides a decoded signal COL to the column ADC block 20. The data processing unit 50 processes data outputted from the column ADC block 20 and generates an image signal.

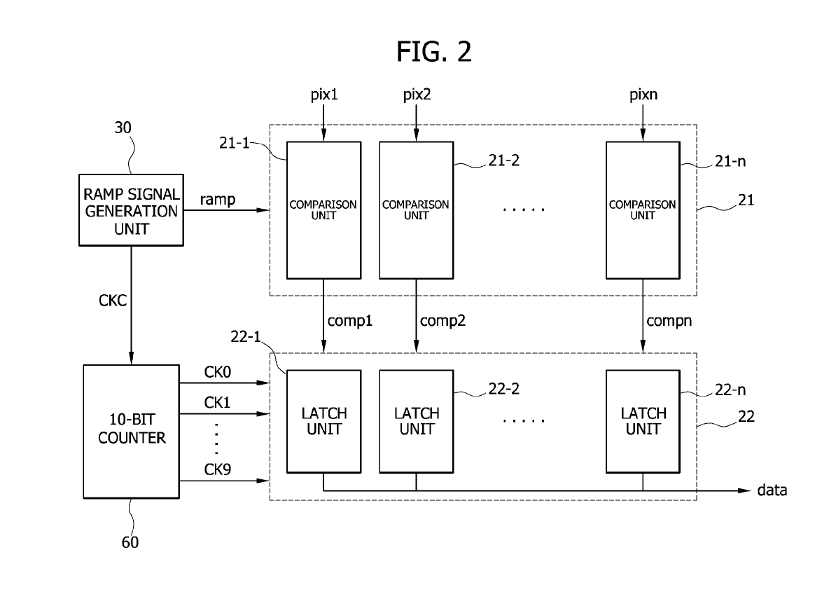

FIG. 2 is a block diagram illustrating the column ADC block and its peripheral circuit in the image sensing device of FIG. 1.

Referring to FIG. 2, the column ADC block 20 includes a comparison block 21 and a latch block 22. The comparison block 21 includes as many comparison units 21-1 to 21-n as the number of columns of the pixel array 10. The latch block 22 includes as many latch units 22-1 to 22-n as the number of columns of the pixel array 10.

Each comparison unit, i.e. 21-1, compares a signal pix1 provided from the corresponding column of the pixel array 10 with a ramp signal ramp, and outputs a comparison signal (for example, comp1). A 10-bit counter 60 starts to perform a counting operation when the ramp signal ramp outputted from the ramp signal generation unit 30 starts to decrease. The ramp signal generation unit 30 generates a count start signal CKC when the ramp signal ramp first starts to decrease, and inputs the counting start signal CKC to the 10-bit counter 60. Each latch unit, i.e. 22-1, latches a count signal CK0-CK9, which is provided from the 10-bit counter 60, in response to a corresponding comparison signal comp1-compn.

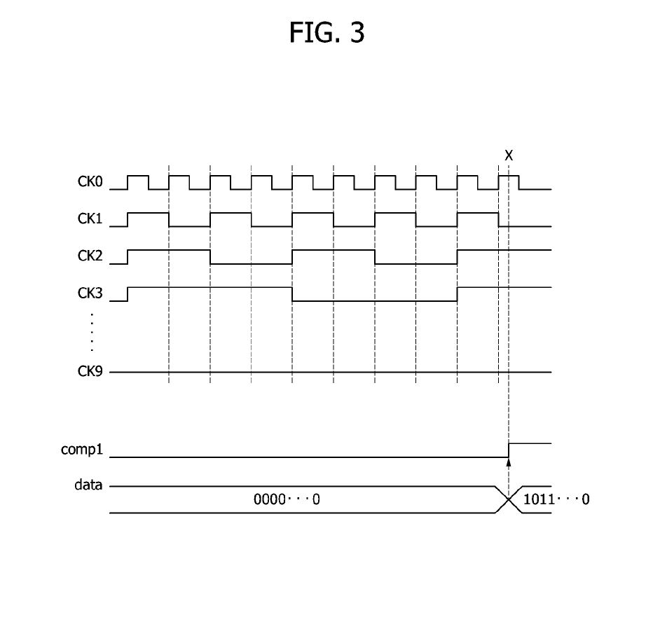

FIG. 3 is a timing diagram illustrating the operation of the column ADC block of FIG. 2.

Referring to FIG. 3, the 10-bit counter 60 performs a counting operation in response to the counting start signal CKC, and provides the respective latch units 22-1 to 22-n with 10-bit output values CK0 to CK9. Each latch unit, i.e. 22-1, latches the count value provided at the activation time point of the comparison signal, i.e. comp1, outputted from the corresponding comparison unit 21-1. For example, a value of “1011 . . . 0” is latched at a time point X. The latched value is outputted as data.

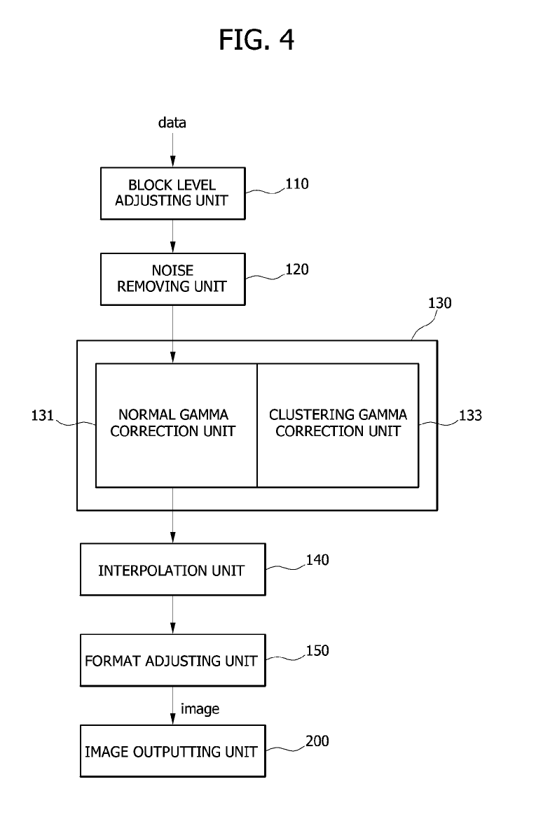

FIG. 4 is a block diagram illustrating an image sensing device in accordance with an embodiment of the present invention.

As shown, an image sensing device in accordance with an embodiment of the present invention includes a block level adjusting unit 110, a noise removing unit 120, a gamma correction unit 130, an interpolation unit 140, a format adjusting unit 150, and an image outputting unit 200.

The block level adjusting unit 110 adjusts a range of digital data provided from pixels. Data provided from pixels do not always have a same range beginning from a same reference value. Data provided from the block level adjusting unit 110 has a value beginning from a same reference value. The noise removing unit 120 removes a noise factor of data provided from the block level adjusting unit 110.

The gamma correction unit 130 is a block for gamma correction. The gamma correction unit 130 includes a normal gamma correction unit 131 and a clustering gamma correction unit 133.

An image sensing device generally uses a gamma correction process. Gamma correction comprises of changing a characteristic of image data so that an image processed by an image sensing device appears as a “real image” in terms of humans' eyes.

The normal gamma correction unit 131 enforces a normal gamma correction process with a reference index. The clustering gamma correction unit 133 is a special block in accordance with an embodiment of the present invention and implements processes to adjust differences depending on each cluster. The interpolation unit 140 extracts red, blue, and green information from each pixel data. The format adjusting unit 150 reformats the interpolated data to data readable by the image outputting unit 200.

An image sensing device in accordance with an embodiment of the present invention includes two gamma correction units, where the normal gamma correction unit 131 implements a normal gamma correction process and the clustering gamma correction unit 133 implements a clustering gamma correction process. These gamma correction units may be used separately, or collectively, to create an image.

The clustering gamma correction unit 133 has an available data range for dividing clusters which corresponds to a predetermined brightness level range. The clustering gamma correction unit 133 arranges a plurality of clusters with image data provided from a pixel array and performs a clustering gamma correction with a corresponding gamma factor regarding each cluster. The corresponding gamma factor may be a value or multiple different values depending on each cluster.

Also, the clustering gamma correction unit 133 may perform the clustering gamma correction with all clusters or selected clusters which have less than a predetermined brightness level value. Data inputted from the clustering gamma correction unit 133 may have various formats and may be a Bayer data format.

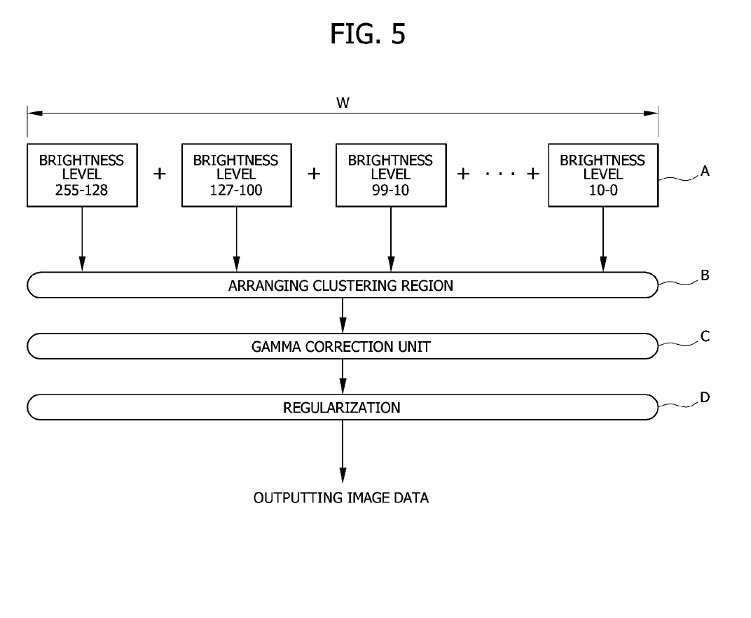

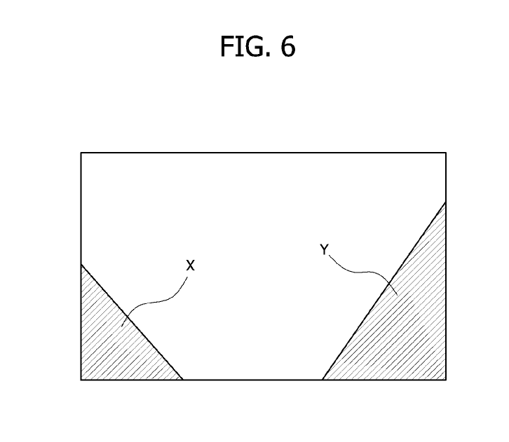

FIG. 5 illustrates an operation of a gamma correction unit of the image sensing device of FIG. 4. FIG. 6 shows an image handled by the gamma correction unit of the image sensing device of FIG. 4.

Available data range in terms of brightness is divided, for instance, 0-10, 10-99, 100-127 and 128-256. Image data provided from the pixel array is divided into a plurality of clusters associated with the divided data range. Each clustering gamma correction is performed with each clustering gamma factor in each cluster. As shown in FIG. 6, there are two portions X and Y having different shades of darkness in an image, and the two portions are arranged into individual clusters in which the clustering gamma correction process is performed with corresponding gamma correction factors. Each clustering gamma correction process may be performed only for clusters having less than a predetermined brightness value.

A normal gamma correction is performed after a clustering gamma correction, and then interpolation processing of image data is performed. R, G, B data is generated from the interpolation process.

The available data range depends on the performance of the image sensing device. For example, given that data for each pixel has 8 bits, the range of brightness in an image sensing device has 0 to 255 steps. The predetermined limit step may be the 99th step, and there may be one cluster with a range of 10 steps above the ninety ninth steps, and another cluster with a range of 5 steps below the 99th step. There may be 12 clusters in total.

To enhance a quality of an image, a gamma correction process is strongly needed in the range of dark values. There needs to be more clusters for dark values and less clusters for bright values. Thus, dark portions of an image need more gamma correction than bright portions of the image.

An image, prior to being performed by an image sensing device, is different from what humans are used to in an image. Bright and dark portions that humans see in real view are different than that viewed by an image sensing device. It is very difficult for dark portions of an image to display clearly in real view. To solve the problem, a dark portion is divided into a cluster and subsequently, a clustering gamma correction process is performed with a predetermined gamma correction factor, as referenced in B and C of FIG. 5. Herein, the clustering gamma correction process may include a K-means clustering method. After the clustering gamma correction process, a normal gamma correction process is performed.

Upon completion of both clustering gamma correction processes, a normalization process is performed. Value variation between two neighboring portions in an image may be significant enough to cause an unsmoothed picture. The normalization process aims to adjust value variation between two portions.

If an image sensing device does not have the clustering gamma correction process and only a normal clustering gamma correction process regarding all image data, including all brightness information, bright values of an image data are implemented too brightly, and dark values of the image are implemented less visibly to the human eye.

However, as described above, an image sensing device in accordance with an embodiment of the present invention can provide a good quality of image that allows humans to see a bright and portions of an image clearly.

While the present invention has been described with respect to the specific embodiments, it will be apparent to those skilled in the art that various changes and modifications may be made without departing from the spirit and scope of the invention as defined in the following claims.

What is claimed is:

1. A method of operating an image sensing device comprising:
dividing a plurality of ranges with an available value width range of the image sensing device associated with a predetermined brightness level range;
dividing a plurality of clusters with image data from a pixels array using the plurality of data ranges; and
performing a clustering gamma correction process for each cluster with at least a clustering gamma correction factor corresponding to each cluster.

2. The method of claim 1, wherein the clustering gamma correction process is performed regarding clusters having data less than a predetermined brightness level.

3. The method of claim 1, wherein the image data includes a Bayer pattern.

4. The method of claim 1, wherein the step of dividing a plurality of ranges includes an arbitrary width of a range for one cluster above a predetermined level, and a width of a range for another cluster above a predetermined level being 5 steps greater than the previous cluster.

5. The method of claim 1, further comprising a step of interpolating data after the clustering gamma correction process.

6. The method of claim 1, further comprising a step of performing a normal gamma correction process.

7. An image sensing device, comprising:
a clustering gamma correction unit for performing a clustering gamma correction process with image data from a pixels array;
a normal gamma correction unit for performing a normal gamma correction process with image data from a pixels array; and
an interpolation unit for interpolating data provided from the clustering gamma correction unit or the normal gamma correction unit.

8. The image sensing device of claim 7, wherein the clustering gamma correction unit:
divides a plurality of ranges with an available value width range of the image sensing device associated with a predetermined brightness level range;
divides a plurality of clusters with the image data from a pixels array using the plurality of data ranges; and
performs a clustering gamma correction process for each cluster with at least a clustering gamma correction factor corresponding to each cluster.

9. The image sensing device of claim 8, wherein the clustering gamma correction process is performed regarding clusters having data less than a predetermined brightness level.

10. The image sensing device of claim 8, wherein an arbitrary width of a range for one cluster above a predetermined level, and a width of a range for another cluster above a predetermined level being 5 steps greater than the previous cluster.

11. The image sensing device of claim 8, wherein the image data includes a Bayer pattern.
